(19) United States
(12) Patent Application Publication
(10) Pub. No.: US 2018/0300814 A1
(43) Pub. Date: Oct. 18, 2018

(54) SYSTEM AND METHOD FOR MANAGING CORPORATE ASSET BACKED SECURITIES

(71) Applicant: M7 VENTURES, LLC, Bedminster, NJ (US)

(72) Inventors: Daniel Joseph McCabe, Upper Saddle River, NJ (US); Mark Steven Criscitello, Colts Neck, NJ (US); Paul Edward Kuhnle, Doylestown, PA (US); John Stuart Thomas, Morristown, NJ (US); George Tedesche Simon, Evanston, IL (US)

(21) Appl. No.: 16/014,921

(22) Filed: Jun. 21, 2018

Related U.S. Application Data
(63) Continuation of application No. 12/966,727, filed on Dec. 13, 2010.
(60) Provisional application No. 61/285,859, filed on Dec. 11, 2009.

(51) Int. Cl. G06Q 40/06; G06Q 40/04; G06F 9/46

(52) U.S. Cl. CPC G06Q 40/06; G06F 9/466; G06Q 40/04

(57) ABSTRACT

Computer methods and systems for managing a bond investment instrument are disclosed. An exemplary method comprises (a) making a determination that a conditional-redemption-bond purchase should be initiated; (b) receiving conditional-redemption bond offering data at an Investment Fund (IF) computer system, wherein the conditional-redemption bond offering data represents bond offerings from one or more bond issuers, and wherein the bond offerings are conditioned upon sale and redemption restrictions including (i) redemptions of the conditional-redemption bonds are permitted when an IF redemption occurs and (ii) redemptions of the conditional-redemption bonds are permitted when the bond issuer has a credit event; (c) using a microprocessor to process the conditional-redemption bond offering data and display at least a subset of the conditional-redemption bond offering data; and (d) transmitting from the IF computer system an electronic purchase request message comprising conditional-redemption bond purchase data including identity and quantity data of one or more selected conditional-redemption bonds.

### CROSS-REFERENCE TO RELATED APPLICATION

This is a Continuation of U.S. application Ser. No. 12/966,727, titled “SYSTEM AND METHOD FOR MANAGING CORPORATE ASSET BACKED SECURITIES”, filed on Dec. 13, 2010, which claims benefit of U.S. Provisional Application No. 61/285,859, filed on Dec. 11, 2009, each of which is hereby incorporated herein by reference in its respective entirety.

### FIELD OF THE INVENTION

The present invention relates to exchanged traded funds and collective investment vehicles.

### BACKGROUND

Exchange Traded Funds, or ETFs, are a type of collective investment vehicle that owns a portfolio of securities and issues shares which are traded on a stock exchange or other organized market. Shares of an ETF are created by authorized participants (AP) by either delivering cash or a portfolio of securities or a combination of cash and securities to the ETF and receiving ETF shares in return. ETF shares may also be redeemed by APs by delivering ETF shares and receiving cash, portfolio securities or a combination thereof. Only an AP may create or redeem ETF shares. All other investors buy or sell ETF shares in an organized market.

Mutual Funds are another type of collective investment vehicle. Mutual Funds typically obtain money from investors, and use it to purchase securities such as company stocks, bonds, or other securities. The mutual fund issues shares to the investors, and the shares are valued as a pro-rata portion of the net asset value (NAV) of the Mutual Fund. The investors may redeem the shares for cash or for the underlying securities held by the Fund. The Mutual Fund manager may trade the asset securities from time to time in an attempt to improve the performance of the Fund's portfolio, or to ensure that the securities held by the Fund accurately reflect the Fund's overall investment strategy.

### BRIEF SUMMARY

Exemplary methods and systems typically involve an investment fund (IF) which issues equity securities (e.g., shares in the IF) backed by a portfolio of debt securities (e.g., bonds) issued by various companies. The IF preferably takes the form of an exchange traded fund (ETF), but may also be a mutual fund, or another type of fund or collective-investment vehicle altogether. The portfolio of debt securities is preferably made up of corporate bonds, and in particular, of bonds that may be referred to as “conditional-redemption” bonds, or “conditional-redemption optional-conversion” bonds. A conditional-redemption bond (CR-Bond) is a debt security that is characterized by a specific set of purchase and redemption conditions, which may allow an IF to offer liquid equity securities backed only by a portfolio of CR-Bonds. As with traditional bonds, a company issuing a CR-Bond may be required to make a payment of a fixed amount, which may be referred to as the stated or par value of the bond, upon maturity of the CR-Bond, and/or to make periodic coupon payments. However, a CR-Bond is a “puttable” bond, which provides the bond holder (i.e., the IF) the option to redeem the bond early under certain conditions. In particular, a CR-Bond is redeemable upon the occurrence of (1) an IF redemption event (i.e., trading of IF shares resulting in the need to sell the underlying assets) or (2) a credit event (i.e., an event defined as effecting the credit worthiness of the issuing company). Furthermore, at least in the scenario where the IF redeems a CR-Bond prior to maturity (and possibly at maturity as well), a CR-Bond provides the issuer with the option of a monetary payment (such as a cash payment) or payment by transfer of equity securities. In a further alternative embodiment, the payment may be made by transfer of an asset having value, such as other securities, bonds, swaps, etc. Thus, the issuer of a CR-Bond is preferably required to provide the bond holder with a security interest in the form of equity (e.g., shares of stock in the issuing company, or other assets of value held by the issuing company).

By issuing IF shares backed by a portfolio of CR-Bonds, an IF may provide numerous benefits for both the investor and issuing companies. For example, by offering shares of equity in an ETF, an ETF may effectively equitize the market for corporate debt securities, thereby providing individual investors with the opportunity to invest in corporate debt securities in the same manner as they would invest in common stock. From the perspective of the investor, the ETF has transformed debt securities (corporate CR-Bonds) into equity securities (shares in the ETF). This may provide access to some investors for whom corporate debt securities might otherwise be inaccessible. Furthermore, the ability of the IF fund manager to redeem the CR-Bond for cash or underlying corporate equity securities upon the occurrence of a credit event (and if needed, to sell the equity securities quickly on a securities exchange), may greatly reduce credit risk for investors, making such investments more attractive to investors with a lower risk tolerance. For issuing companies, the reduced credit risk may result in lower financing costs and more generally, provide a new option for short-term financing needs. Moreover, in some embodiments where the redemption of CR-Bonds is paid in corporate securities, the issuing companies may find the option of payment in equity rather than cash desirable as it provides flexibility upon redemption.

In one embodiment, a computer method of managing a bond investment instrument is disclosed. The method comprises (a) making a determination that a conditional-redemption-bond purchase should be initiated; (b) receiving conditional-redemption bond offering data at an Investment Fund (IF) computer system, wherein the conditional-redemption bond offering data represents bond offerings from one or more bond issuers, and wherein the bond offerings are conditioned upon sale and redemption restrictions including that the conditional-redemption bonds are permitted to be purchased or redeemed only in a transaction with a corresponding bond issuer, and either (i) redemptions of the conditional-redemption bonds are permitted when an IF redemption occurs or (ii) redemptions of the conditional-redemption bonds are permitted when the bond issuer has a credit event; (c) using a microprocessor to process the conditional-redemption bond offering data and display at least a subset of the conditional-redemption bond offering data; and (d) transmitting from the IF computer system an electronic purchase request message comprising conditional-redemption bond purchase data including identity and quantity data of one or more selected conditional-redemption bonds.

In another embodiment, an apparatus for managing a bond investment instrument is disclosed. The apparatus is preferably implemented at an IF computer system. The apparatus comprises (a) a computer communications interface device and message parsing apparatus configured to receive conditional-redemption bond offering data representing bond offerings of one or more bond issuers, wherein the bond offerings are conditioned upon sale and redemption conditions, wherein the sale and redemption restrictions comprise: (1) a restriction that the conditional-redemption bonds are permitted to be purchased or redeemed only in a transaction with a corresponding bond issuer and (2) a restriction that redemption of the conditional-redemption bond is permitted only when (i) an IF redemption occurs or (ii) when the bond issuer has a credit event; (c) a display device configured to display at least a subset of received conditional-redemption bond offering data. Preferably, the computer communications interface device further configured to transmit an electronic purchase request message comprising conditional-redemption bond purchase data including identity data and quantity data for selected conditional-redemption bonds.

In another embodiment, an apparatus for managing a bond investment instrument is disclosed. The apparatus is preferably implemented at an authorized participant (AP) computer system. The apparatus comprises: (a) a receive interface on a bond-instrument consolidator computer system adapted to receive and process conditional-redemption bond-offering data representing bond offerings associated with a respective plurality of conditional-redemption bond instruments from a plurality of bond issuer computer systems; (b) an electronic database for storing the conditional-redemption bond-offering data; (c) a transmit interface on a bond-instrument consolidator computer system for transmitting at least a subset of the conditional-redemption bond-offering data to an investment fund (IF) computer system wherein the bond offerings are conditioned upon sale and redemption conditions, wherein the sale and redemption restrictions comprise: (1) a restriction that the conditional-redemption bonds are permitted to be purchased or redeemed only in a transaction with a corresponding bond issuer; and (2) a restriction that redemption of the conditional-redemption bond is permitted only when (i) an IF redemption occurs or (ii) when the bond issuer has a credit event; (c) an electronic database for storing the conditional-redemption bond-offering data, and (d) a transaction processor adapted to (i) process an electronic purchase request message electronically received from the IF computer system, wherein the electronic purchase request message comprises conditional-redemption bond purchase data including identity and quantity data of one or more selected conditional-redemption bonds and (ii) generate at least one electronic transaction message comprising at least a subset of the conditional-redemption bond purchase data for transmission to at least one bond issuer computer system.

In another embodiment, a computer method of managing a bond investment instrument is disclosed. The method comprises (a) making a determination that a conditional-redemption-bond redemption should be initiated, (b) at an investment fund (IF) computer system, retrieving IF portfolio data from an electronic database for a portfolio of conditional-redemption bonds, wherein the IF portfolio data comprises identity and quantity data for the conditional-redemption bonds in the portfolio; (c) using a microprocessor to process the IF portfolio data and display the identity and quantity data for at least a subset of the conditional-redemption bonds; and (d) transmitting from the IF computer system an electronic redemption request comprising identity and quantity data for selected conditional-redemption bonds, wherein the redemption request may be satisfied by (i) receipt of monetary funds equal to a present value of the selected conditional-redemption bonds or (ii) receipt of securities substantially equal to the present value of the selected conditional-redemption bonds.

In another embodiment, an apparatus for managing a bond investment instrument is disclosed. The apparatus comprises a receive interface on a bond-instrument consolidator computer system adapted to receive and process an electronic redemption request from an investment fund (IF) for redemption of a plurality conditional-redemption bonds. Preferably, the electronic redemption request comprises conditional-redemption bond data that comprises identity data and quantity data for the conditional-redemption bonds. Further, redemption of the conditional-redemption bonds is preferably conditioned upon sale and redemption conditions, wherein the sale and redemption conditions comprise: (i) a restriction that the conditional-redemption bonds are permitted to be purchased or redeemed only in a transaction with a corresponding bond issuer; and (ii) a restriction that redemption of the conditional-redemption bond is permitted only when (i) an IF redemption occurs or (ii) when the bond issuer has a credit event. The apparatus further comprises a redemption verification system adapted to verify that the redemption conditions are satisfied for the selected conditional-redemption bonds and a transmit interface on a bond-instrument consolidator computer system adapted to transmit an electronic redemption request comprising conditional-redemption bond data for the conditional-redemption bonds verified by the redemption verification system, wherein the redemption request may be satisfied by (i) payment of monetary funds to the IF equal to a present value of the conditional-redemption bonds or (ii) transfer of securities to the IF substantially equal to the present value of the conditional-redemption bonds.

In another embodiment, a transformational bond-investment instrument for providing equity shares in a portfolio of debt securities is disclosed. The instrument comprises (a) an interface for issuing equity shares in an investment fund, wherein the equity shares provide shareholders with a stake in a portfolio of conditional-redemption bonds, wherein the conditional-redemption bonds are purchased from one or more bond issuers, wherein redemption of the conditional-redemption bonds is conditioned upon sale and redemption conditions, wherein the sale and redemption conditions comprise a condition that redemption of the conditional-redemption bond is permitted when (i) an IF redemption occurs or (ii) when the bond issuer has a credit event, and wherein a redemption request for one or more of the conditional-redemption bonds the may be satisfied by (i) payment of monetary funds to the IF equal to a present value of the redeemed conditional-redemption bonds or (ii) transfer of securities to the IF substantially equal to the present value of the redeemed conditional-redemption bonds; (b) an interface for receiving a net trading position indicative of trading in equity shares of the investment fund over a predetermined period of time; and (c) a system for using the net trading position to determine if at least a portion of the portfolio of conditional-redemption bonds should be purchased or redeemed, wherein, if it is determined that at least a portion of the portfolio of conditional-redemption bonds should be purchased, the system initiates a creation event; and wherein, if it is determined that at least a portion of the portfolio of conditional-redemption bonds should be redeemed, the system initiates a redemption event.

In another embodiment, a method is disclosed for managing a transformational bond-investment instrument, wherein equity shares in the bond-investment instrument have a value based on a portfolio of conditional-redemption bonds. The method comprises (a) receiving a net trading position indicative of trading in equity shares of the bond-investment instrument; wherein redemption of the conditional-redemption bonds is conditioned upon sale and redemption conditions, wherein the sale and redemption conditions comprise a condition that redemption of the conditional-redemption bond is permitted when (i) an IF redemption occurs or (ii) when the bond issuer has a credit event; and wherein a redemption request for one or more of the conditional-redemption bonds the may be satisfied by (i) payment of monetary funds to the IF equal to a present value of the redeemed conditional-redemption bonds or (ii) transfer of securities to the IF substantially equal to the present value of the redeemed conditional-redemption bonds; (b) using the net trading position as a basis for determining if at least a portion of the portfolio of conditional-redemption bonds should be purchased or redeemed; (c) if it is determined that at least a portion of the portfolio of conditional-redemption bonds should be purchased, initiating a creation event to purchase one or more conditional-redemption bonds for the portfolio; and (d) if it is determined that at least a portion of the portfolio of conditional-redemption bonds should be redeemed, initiating a redemption event to sell one or more of the conditional-redemption bonds from the portfolio.

These as well as other aspects, advantages, and alternatives will become apparent to those of ordinary skill in the art by reading the following detailed description, with reference where appropriate to the accompanying drawings.

### BRIEF DESCRIPTION OF THE DRAWINGS

FIG. 1A depicts a system in which an investment fund may be implemented, according to an exemplary embodiment;

FIG. 1B is a block diagram illustrating a computer system that may be used to implement various transactions and data transfers associated with operation of an exemplary investment fund;

FIG. 2A is a flow chart illustrating a method that may be implemented by an investment fund to purchase conditional-redemption bonds, according to an exemplary embodiment;

FIG. 2B is a flow chart illustrating a method that may be implemented by an investment fund to redeem conditional-redemption bonds, according to an exemplary embodiment;

FIG. 3A is a transaction-flow diagram illustrating transactions of monetary funds and securities between various entities, associated with an exemplary creation event;

FIG. 3B is a message-flow diagram illustrating the electronic-message flow between various entities, associated with an exemplary creation event;

FIG. 4A is a is a transaction-flow diagram illustrating transactions of monetary funds and securities between various entities, which may be associated with an exemplary redemption event; and

FIG. 4B is a message-flow diagram illustrating the electronic-message flow between various entities, associated with an exemplary redemption event.

### DETAILED DESCRIPTION

Exemplary methods and systems will now be described with reference to the IF taking the form of an exchange traded fund (ETF). It should be understood, however, that features and functionality attributed to an ETF may apply equally to mutual funds, as well as other types of collective-investment vehicles, and are considered to be alternative implementations to the ETF embodiment described below.

### Exemplary Systems

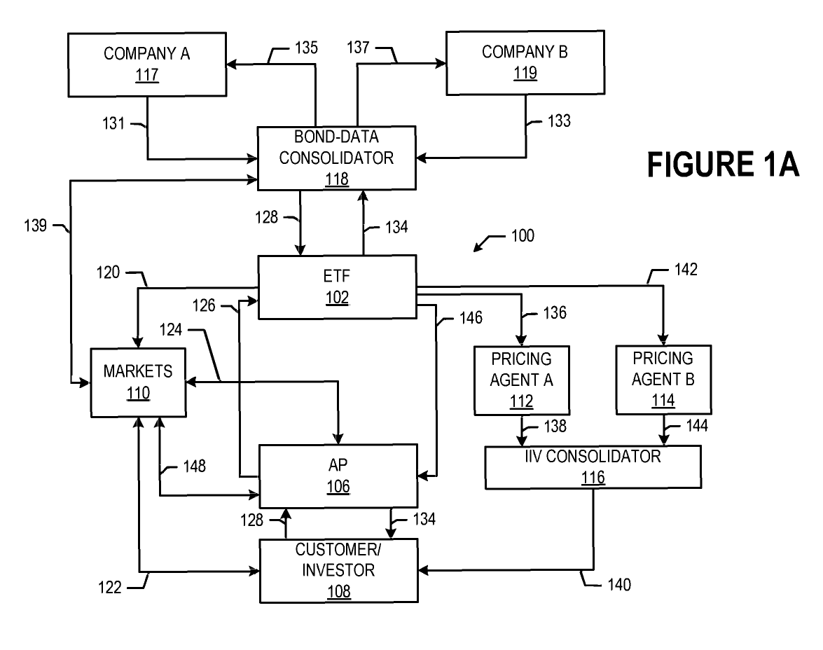

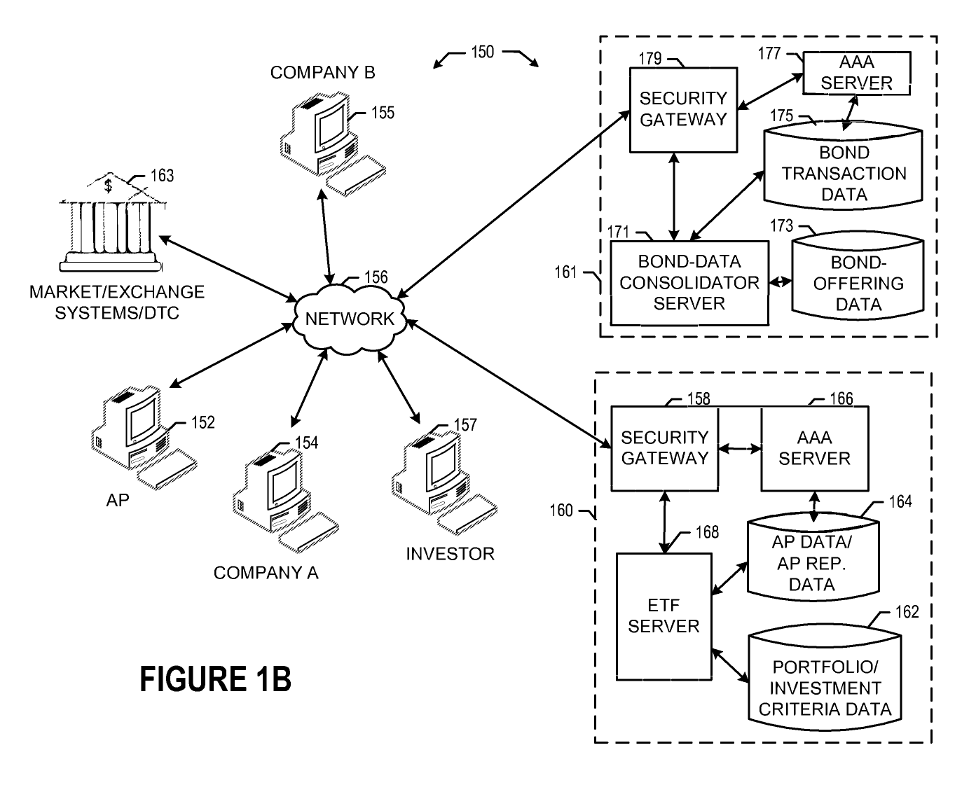

With reference to FIG. 1A, a system 100 in which an exemplary ETF may be implemented will be described. The ETF 102 may engage in market transactions 120 with the markets 110. The authorized participant (AP) 106 may interact with the ETF 102 directly as shown by transaction 126, or possibly via an AP representative (not shown) that serves as an intermediary between AP 106 and markets 110. The AP 106 may buy and sell ETF shares to customers 108 as shown by transaction 128, 134, or in the market 110 as shown by transaction 148.

Also shown is bond-data consolidator 118, which may provide bond-offering data to ETF 102, as shown by transaction 128. The bond-offering data may identify and/or provide information relating to bonds (such as CR-Bonds) that are being offered by company A 117 and company B 119. Accordingly, company A 117 and company B 119 may provide bond-offering data indicating their respective bond offerings to bond-data consolidator 118, as shown by transactions 131 and 133, respectively. Bond-data consolidator 118 may also receive bond purchase and redemption requests from ETF 102, and may relay these requests to company A 117 and company B 119, as shown by transactions 135 and 137, respectively.

In general, the transactions described herein may involve the transfer of equity securities(such as common stock) and/or debt securities (such as bonds) between various entities such as the ETF 102, the AP 106, publicly-traded corporations (such as company A 117 and company B 119), privately-held companies (not shown), a bond-data consolidator 118, an investor 108, and/or a securities exchange such as market 110. It should be understood that the transfer of such securities is preferably performed electronically via suitable messaging formats and systems well known to those of skill in the art. For instance, the Depository Trust Company (DTC) (not shown) provides a participant terminal system for transferring securities using electronic messaging. Thus, an electronic transfer of securities is preferably performed by sending an electronic message to the DTC. The DTC then performs a book entry movement by executing an accounting entry to move securities from one account to another account.

The AP is preferably a bank, broker-dealer, exchange specialist, market maker, arbitrageur or, possibly, an institutional investor. The AP enters into an agreement with the ETF setting the terms for the creation and redemption of the ETF shares in creation unit aggregations. Preferably, a representative relationship such as via a blind trust or other agency vehicle is established by the AP as part of the agreement between and AP and the ETF.

The bond-data consolidator 118 may be an arm of an investment bank, a custodial division, or another financial institution, or may be established as an independent financial institution. A bond-data consolidator 118 preferably functions as a service company that provides bond issuing entities with increased access to investment funds such as ETF 102 or other ETF's mutual funds or other collective investment vehicles, and provides aggregated information to potential investors in CR-Bonds.

Furthermore, bond-data consolidator 118 may operate as an intermediary between bond-issuing companies, such as company A 117 and company B 119, and ETF 102 by validating redemption requests and or assisting in the transactions related to the sale and/or purchase of bonds. For example, company A 117 and company B 119 are preferably required to file a “shelf registration” of stock, so that stock is available in the event that company A 117 or company B 119 elects to make payment for a CR-Bond using stock. A shelf registration is a filing with the U.S. Securities and Exchange Commission (SEC), which registers a new issue of stock up to two years in advance, so that the stock can be more quickly offered on the market at a later date. Accordingly, when company A 117 or company B 119 elects make payment for a CR-Bond in stock, bond-data consolidator 118 may receive the stock from the shelf registration, on behalf of ETF 102. Bond-data consolidator 118 then sells the stock on market 110, as shown by transaction 139, and sends the funds received for the stock to ETF 102.

A further aspect of an ETF is the calculation and reporting of the intraday indicative value, or IIV. In order to maintain the confidentiality of the holdings the managed ETF, the ETF 102 may provide partial position information 136, 142 to a plurality of pricing agents, such as pricing agent A 112 and pricing agent B 114. The pricing agents then provide partial pricing data 138, 144 to the IIV consolidator 116. The IIV consolidator 116 consolidates the partial pricing data into an IIV, and provides the ETF IIV 140 to customers 108 (and to markets 110 generally). By using a plurality of pricing agents, the ETF manager is able to maintain the confidentiality of the precise makeup of the ETF 102.

Alternatively, the IIV consolidator 116 may be the ETF custodian, or another entity that has authorized access to the confidential identity of the holdings of the managed ETF, and may compute the pricing information directly without the use of a pricing agent. The IIV consolidator provides ETF quotes 140 to customer 108 (and to markets 110 generally) by electronically publishing the IIV via a data communication feed. By using a plurality of pricing agents, the ETF manager is able to maintain the confidentiality of the precise makeup of the ETF 102.

With reference to FIG. 1B, a computer system, or system networked computers 150, may be used to implement various transactions and data transfers associated with operation of the ETF described herein. The system 150 preferably includes an AP workstation 152, ETF system 160, a bond-data consolidator system 161, a market/exchange system or DTC 163, and company workstations including company A workstation 165 and company B workstation 167. The various components communicate over network 156, which may be a public network such as the Internet, or a private network including leased lines, or a virtual private network using virtual private network (VPN) protocols.

ETF system 160 preferably includes ETF server 168, database 162 (which contains information relating to the ETF portfolio securities and creation and redemption baskets), and database 164 (which contains data relating to the APs, such as identification information, password files, encryption keys, other access authorization and accounting (AAA) data). In this regard, ETF system 160 may optionally include AAA server 166 and a security gateway 158.

Bond-data consolidator system 161 preferably includes bond-data consolidator server 171, database 173, and database 175. Database 173 preferably stores data relating to bond-offerings from companies such as those received via company A workstation 165 and company B workstation 167. Database 175 preferably stores data relating to bond transactions, such as the identity of parties (e.g., IFs, issuing companies, etc.) involved in the bond transactions and details of specific bond transactions. Further, database 175 may store authorization information relating to involved parties, such as identification information, password files, encryption keys, other access authorization and accounting (AAA) data. In this regard, bond-data consolidator system 161 may optionally include AAA server 177 and a security gateway 179.

The systems described herein, such as those shown in FIGS. 1A and 1B, may include computer readable storage media for use with computer systems to effectuate certain steps described herein. In particular, the computer-readable media may contain instructions to cause a microprocessor to execute the functions described herein.

The various transactions and transfers described herein preferably take place using the systems and components shown in FIG. 1B, although one of skill in the art will appreciate that many variations of the system may be implemented without departing from the scope of the invention. Suitable networking protocols may be used, including the Transport Control Protocol/Internet Protocol (TCP/IP) suite of protocols, and also including the HyperText Transport Protocol (HTTP) and associated security protocols HTTPS, and other mechanisms such as Virtual Private Networking (VPN), Secure Sockets Layer (SSL), Transport Layer Security (TLS), tunneling protocols such as Generic Routing and Encapsulation (GRE), Layer 2 Tunneling Protocol (L2TP), and the like. Another protocol that may be used to facilitate the transactions and associated messaging described herein is the Financial Information eXchange (FIX) Protocol, which is a messaging standard developed specifically for the real-time electronic exchange of securities transactions. FIX is a public-domain specification owned and maintained by FIX Protocol, Ltd. In addition, some of the transactions may be communicated in a manual fashion, such as via telephone or textual messaging (email, and the like), whereupon the relevant transaction information may be entered into the appropriate computer systems.

### Exemplary Methods

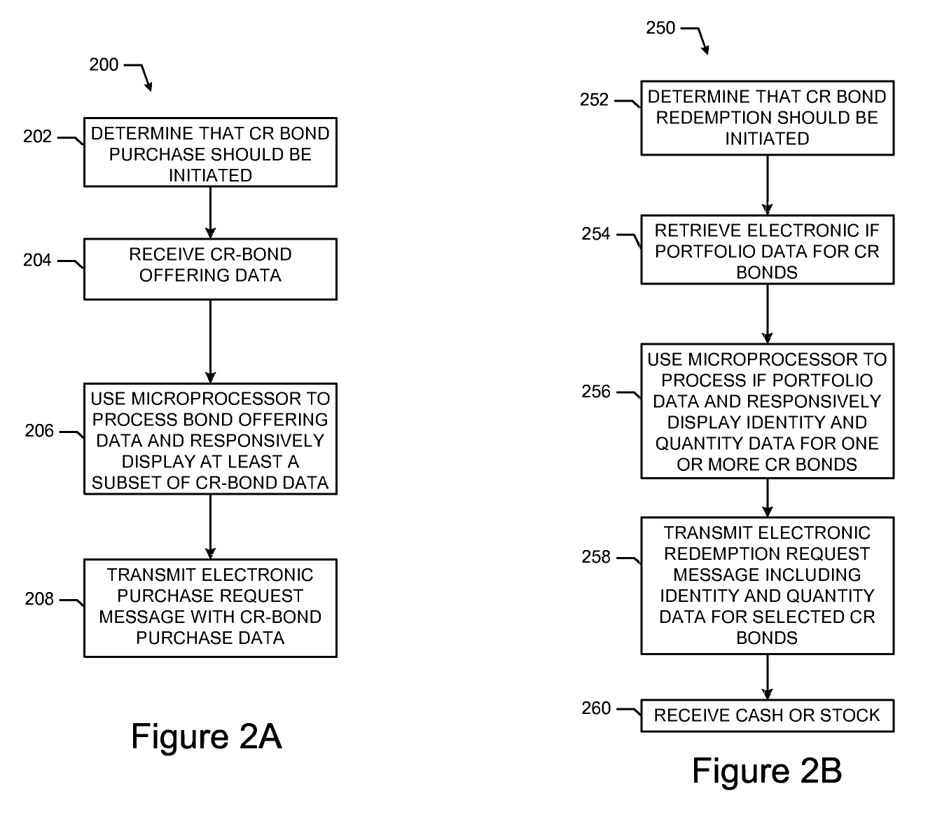

FIGS. 2A and 2B are both flow charts illustrating a computer method for managing a bond-investment instrument, according to an exemplary embodiment. More specifically, FIG. 2A illustrates a method 200 that may be implemented by an IF to purchase CR-Bonds, while FIG. 2B illustrates a method 200 that may be implemented by an IF to redeem CR-Bonds, according to an exemplary embodiment.

The methods described herein, including those described in reference to FIGS. 2A and 2B, may be carried out by an IF computer system include computer readable storage media for use with computer systems to effectuate certain steps described herein. In particular, the computer-readable media may contain instructions to cause a microprocessor to execute the methods described herein.

With reference to the method 200 illustrated in FIG. 2A, the IF computer system initially makes a determination that a conditional-redemption-bond purchase should be initiated, as shown by block 202. The IF system then receives conditional-redemption bond offering data, which represents bond offerings from one or more bond issuers, as shown by block 204. The IF system then processes the conditional-redemption bond offering data and displays at least a subset of the conditional-redemption bond-offering data on a display screen, as shown by block 206. Then, once one or more bonds are selected for purchase from the displayed conditional-redemption bond-offering data, the IF system transmits an electronic purchase request message, which includes conditional-redemption bond purchase data (e.g., identity and quantity data) for the selected conditional-redemption bonds, as shown by block 208.

As the bond-offerings represented in the bond-offering data are for CR-Bonds, the bond offerings are conditioned upon the sale and redemption conditions associated with CR-Bonds. More specifically, three basic conditions typically apply to CR-Bonds. These conditions include (1) that the CR-Bonds are only permitted to be purchased or redeemed in a transaction with a corresponding bond issuer (i.e., the CR-Bonds are non-transferrable); (2) that while CR-Bonds are typically redeemable upon maturity in the same manner as traditional bonds, redemption of CR-Bonds is also permitted (a) when an IF redemption occurs or (b) when the bond issuer has a credit event; and (3) that by transmitting the purchase request and agreeing to purchase a CR-Bond from the issuing company, the IF agrees that upon redemption, the issuer has the option of (a) a monetary payment (e.g., a transfer of monetary funds) or (b) equity payment (e.g., transfer of the company's stock).

With reference to the method 250 illustrated in FIG. 2B, the IF computer system initially makes a determination that a CR-Bond redemption should be initiated, as shown by block 252. The IF computer system then retrieves IF portfolio data from an electronic database for at least a subset of a portfolio of conditional-redemption bonds, as shown by block 254. The IF portfolio data preferably includes identity and quantity data for the conditional-redemption bonds held by the IF. The IF computer system then processes the IF portfolio data and displays conditional-redemption-bond data for at least a subset of the conditional-redemption bonds in the portfolio, as shown by block 256. Then, once one or more bonds are selected for redemption from the displayed conditional-redemption bond-offering data, the IF system transmits an electronic redemption request, which preferably includes identity and quantity data for the selected conditional-redemption bonds, as shown by block 258.

As the redemption request is for redemption of CR-Bonds, the redemption request must comply with the defined conditions for CR-Bonds set forth herein (i.e., CR-Bonds are non-transferrable, allow for early redemption upon IF redemption or credit event, and provide the option for monetary or equity payment). Accordingly, the redemption request may be satisfied by (i) receipt of monetary funds (i.e., cash or cash equivalent) equal to a present value of the selected conditional-redemption bonds or (ii) receipt of securities (i.e., stock) substantially equal to the present value of the selected conditional-redemption bonds, as shown by block 260.

### Exemplary ETF Creation Event

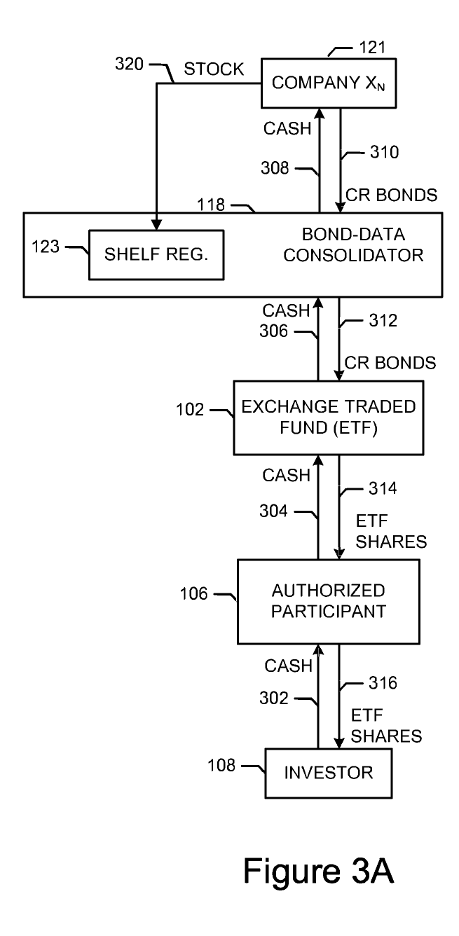

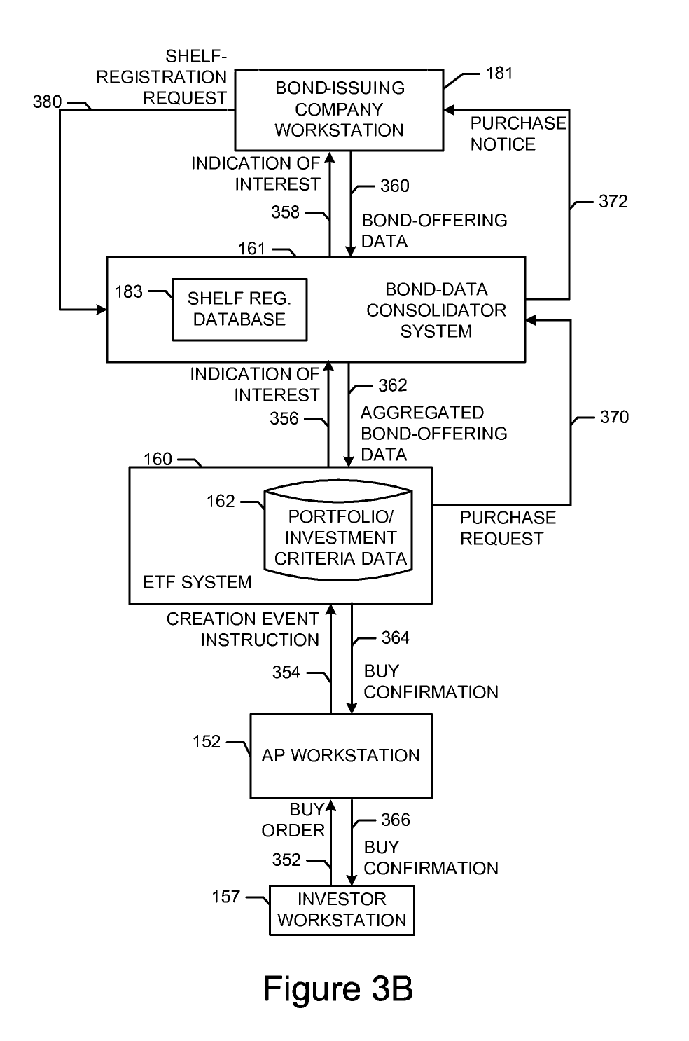

FIGS. 3A and 3B are block diagrams illustrating a method and system 300 for managing a bond-investment instrument, according to an exemplary embodiment. In the illustrated embodiment, the bond-investment instrument is an ETF 102. Referring to FIG. 3A more specifically, it illustrates transactions of monetary funds and securities between ETF 102, AP 106, bond-data consolidator 118, bond-issuing company 121 (which may be one of multiple issuing companies such as company A 117 and company B 119), and investor 108, which may be associated with an exemplary creation event. FIG. 3B illustrates the electronic-message flow between computer systems of these entities, which include an ETF system 160, an AP workstation 152, a bond-data-consolidator system 161, a bond-issuing-company workstation 181 (which may be one of multiple bond-issuing-company workstations such as company A workstation 154 and company B workstation 155), and an investor workstation 157, which are associated with an exemplary creation event.

Referring to both FIGS. 3A and 3B, the ETF 102 preferably initiates a creation event to issue ETF shares to investors 108 in response to a creation-event instruction 354 from AP workstation 152. More specifically, the AP typically receives a buy order 352 from investor workstation 352 (preferably via a market/exchange and/or a DTC), as well as buy orders from other investor workstations. Buy order 352 is typically accompanied by a transfer of monetary funds from investor 108 to AP 106, as shown by transaction 302. The AP workstation 161 preferably nets all buy and sell orders periodically, such as once each business day. Then, if it is determined that the net position of all orders requires the creation of additional ETF shares, such as may be determined when the quantity of buy orders exceeds the quantity of sell orders, the AP workstation 152 transmits a creation-event instruction 354 to ETF system 160. The creation-event instruction 354 is typically accompanied by a transfer of the monetary funds received from the investor 108 to ETF 102, as shown by transaction 304.

In response to creation-event instruction 354, ETF 102 issues ETF shares, which are transferred to AP 106, as shown by transaction 314. The AP 106 then relays the ETF shares to investor 108, as shown by transaction 316. Further, in conjunction with the issuance of ETF shares, ETF system 160 may send a buy confirmation to AP workstation 152, as shown by transaction 364, which the AP workstation 152 then relays to investor workstation 157, as shown by transaction 366.

Preferably, ETF shares are valued based on a net asset value (NAV) of the ETF's assets, which in the exemplary embodiment, are a portfolio of CR-Bonds. Therefore, the NAV for the ETF is a function of the net present value (NPV) of the CR-Bonds in its portfolio. The NPV for a CR-Bond may be determined based on the interest rate of the bond and the model interest rate at the time NPV is calculated.

Also in response to creation-event instruction 354, ETF system 160 may send an indication of interest 356 to bond-data-consolidator system 161, which indicates that ETF 102 desires information regarding available CR-Bonds. Accordingly, bond-data-consolidator system 161 responds by sending aggregate bond-offering data 362 to ETF system 160. To facilitate this, bond-issuing company 181 and other bond-issuing companies send bond-offering data 360, which identifies offers of CR-Bonds by the companies, to bond-data-consolidator system 161. The bond-issuing companies may send bond-offering data on their own accord, or alternatively, in response to an indication of interest 358 from bond-data-consolidator system 161.

ETF system 160 may process the aggregate bond-offering data and display at least a subset of available CR-Bonds. Preferably, ETF system 160 functions to apply investment criteria stored in database 162 in order to filter the displayed bond-offering data. For instance, ETF system 160 may retrieve ETF investment criteria data from database 162 and apply the ETF investment criteria to select which CR-Bonds, and/or what specific bond-offering data associated with each selected CR-Bond, should be displayed. The ETF system 160 may then function to arrange the selected bond-offering data, such as by ranking the selected CR-Bonds to provide a suggested priority or ranking for purchase, for instance. Alternatively, ETF system 160 may select certain CR-Bonds and/or the specific bond-offering data to display, without any particular arrangement, or conversely, arrange and display all bond-offering data (such as by ranking and displaying all CR-Bonds available for purchase).

In another alternative embodiment, ETF system 160 may further apply the ETF investment criteria to automatically select CR-Bonds to purchase. As such, it is possible that purchase request 370 may be generated and sent without any input from the fund manager. Further, it is also within the scope of the invention that the ETF system 160 may simply display all bond-offering data, without any particular arrangement or filtering.

Once CR-Bonds are selected for purchase (either by a fund manager or automatically by ETF system 160), ETF system 160 sends purchase request 370 to the bond-data consolidator system 161. The ETF may also transfer the funds received from the AP for shares in the ETF, as shown by transaction 306. The bond-data consolidator 118 may then transfer the funds to the bond-issuing company 121, as shown by transaction 308. In conjunction with this transfer, bond-data consolidator system 161 may send a purchase notice 372 to the bond-issuing company workstation indicating that the bond offer has been accepted. The purchased CR-Bonds are then transferred to bond-data consolidator 118 (if they have not already been transferred), as shown by transaction 310. The bond-data consolidator 118 may hold the CR-Bonds on behalf of the ETF 102, or alternatively transfer the bonds to ETF 102, as shown by transaction 312.

In a further aspect, bond-issuing company 121 may file a shelf registration 123 with the bond-data consolidator 118, as shown by transaction 320. The shelf registration 123 is preferably for stock equal in value to the par value for the issued CR-Bond, thereby providing collateral for the CR-Bond. Bond-data consolidator coordinates filing with SEC, and can issue shares upon instruction from company. Alternatively, file with separate entity or possibly internally. To implement the shelf registration transaction 320, company workstation 181 sends a shelf-registration request 380 to bond-data consolidator system 161. The shelf registration may be stored in a shelf registration database 183.

### Exemplary ETF Redemption Event

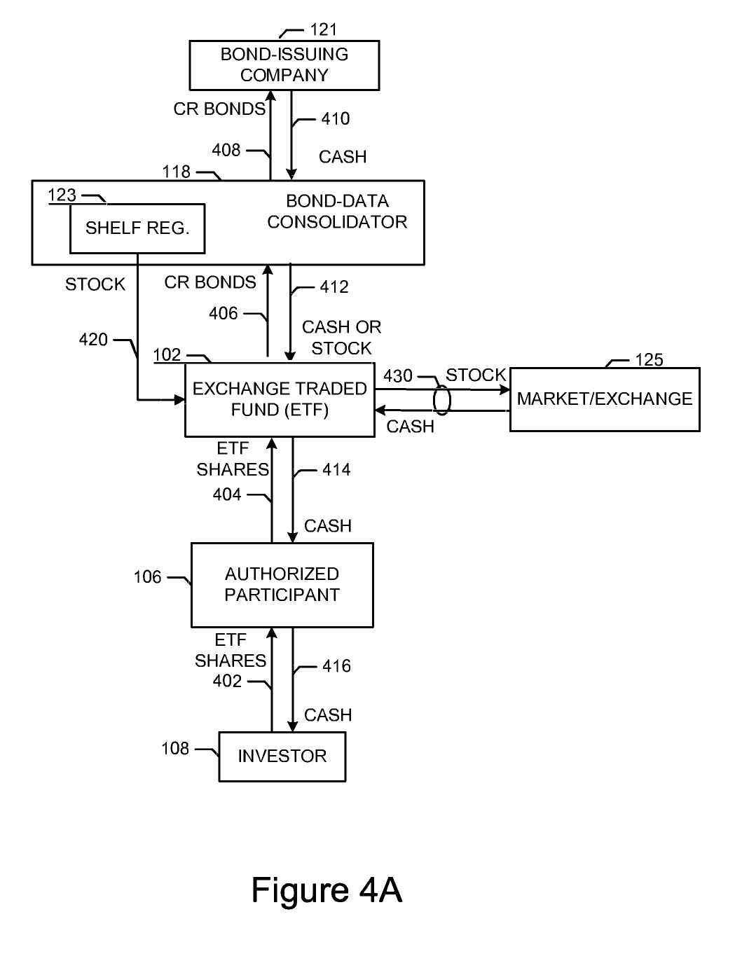

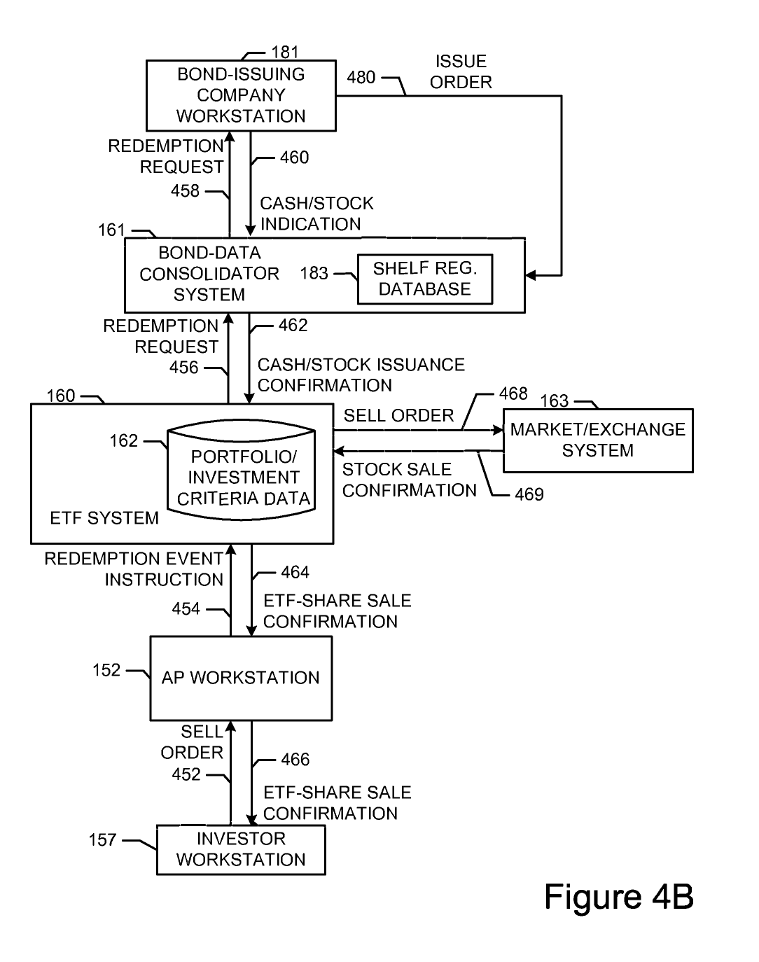

FIGS. 4A and 4B are block diagrams illustrating a method and system 400 for managing a bond-investment instrument, according to an exemplary embodiment. In the illustrated embodiment, the bond-investment instrument is an ETF 102. Referring to FIG. 4A more specifically, it illustrates transactions of monetary funds and securities between ETF 102, AP 106, bond-data consolidator 118, bond-issuing company 121 (which may be one of multiple issuing companies such as company A 117 and company B 119), and investor 108, which may be associated with an exemplary redemption event. FIG. 4B illustrates the electronic-message flow between computer systems of these entities, which include an ETF system 160, an AP workstation 152, a bond-data-consolidator system 161, a bond-issuing-company workstation 181 (which may be one of multiple bond-issuing-company workstations such as company A workstation 154 and company B workstation 155), and an investor workstation 157, which may be associated with the same exemplary redemption event.

Referring to both FIGS. 4A and 4B, the ETF 102 may initiate a redemption event to redeem one or more CR-Bonds with one or more bond-issuing companies, such as bond-issuing company 121 (a “CR-Bond redemption event”). The ETF 102 may determine that the CR-Bond redemption event should be initiated for various reasons in accordance with the redemption conditions of a CR-Bond. In particular, the CR-Bonds may be redeemed upon maturity, upon a credit event, or as illustrated, in response to an “ETF redemption event” (such as a sale of ETF shares by investor 108). At the system level, ETF system 160 may initiate the CR-Bond redemption event in response to a redemption-event instruction 454 from AP workstation 152.

More specifically, the AP workstation 152 typically receives a sell order 452 from investor workstation 157 (preferably via a market/exchange system 163 and/or a DTC), as well as sell orders from other investors. The AP workstation 161 preferably nets all buy and sell orders periodically, such as once each business day. Then, if it is determined that the net position of all orders requires the sale of CR-Bonds in order to complete the sale of ETF shares and make payment to investor 108, such as may be determined when the quantity of sell orders exceeds the quantity of buy orders, the AP workstation 152 transmits a redemption-event instruction 454 to ETF system 160.

For simplicity, FIG. 4A shows AP 106 receiving ETF shares from investor 108, as shown by transaction 402, and relaying the ETF shares to ETF 102, as shown by transaction 404. It is within the scope of the invention that the investor will hold ETF shares, and thus transfer the shares upon sale. However, in practice, a DTC or another entity will typically hold the ETF shares on behalf of investor 108, and work with the AP 404 to effectuate a sale of the shares. In addition, the ETF shares may not be physically transferred, and instead the sale of a share may simply take the form of a changing a record in a database, such as by ETF system 160 storing data to indicate a sale of the shares in a portfolio database 162. Furthermore, transfer of CR-Bonds between ETF 102, bond-data consolidator 118, and/or bond-issuing company 121, as shown by transactions 406 and 408, may similarly involve a DTC and/or be effectuated electronically in databases maintained by the respective entities.

In a further aspect, it should be understood that the redemption-event instruction 454 (or the creation-event instruction 454 in FIG. 4B) may be an implicit or explicit instruction. For example, the instruction may be an explicit instruction to sell (or purchase) CR-Bonds. However, the instruction may also be implicit, such as by indicating a net trading position based on the aggregate buy and sell orders during a given day. For instance, ETF system 160 may receive a net activity report from the AP workstation 152, which aggregates all buy and sell orders received during a given day to provide a net position (i.e., the net trading position of ETF shares for the day). Based on the net trading position, ETF system 160 may determine whether CR-Bonds should be redeemed (i.e., an implicit redemption-event instruction) or purchased (i.e., an implicit creation-event instruction). Alternatively, the ETF system 160 may display the net position and provide an interface for use by a fund manager in selecting whether to sell or purchase CR-Bonds.

In response to redemption-event instruction 454, ETF 102 may transfer payment for the redeemed ETF shares to investor 108 (preferably via AP 106 and/or a DTC), as shown by transactions 414 and 416. Further, in conjunction with the transfer of funds to the investor 108, ETF system 160 may send an electronic ETF-share sale confirmation 464 to AP workstation 152, which then relays an ETF-share sale confirmation 466 to investor workstation 157. Alternatively or additionally, ETF system 160 may send ETF-share sale confirmation 464 to the investor directly, such as by sending an e-mail to the account buy confirmation to AP workstation 152, and/or by generating a letter to be sent to the investor via standard mail.

Also in response to the redemption-event instruction 454, ETF system 160 may retrieve portfolio data from database 162, which includes identity and quantity data for the C-R bonds in the ETF portfolio. Further, ETF system 160 may process the portfolio data and display portfolio data for at least a subset of the CR-Bonds in the ETF portfolio, in order that a fund manager can review the portfolio data and select CR-Bonds to redeem. In this regard, ETF system 160 may also include a user interface for receiving input indicating CR-Bonds selected to be redeemed. The user interface may allow the fund manager to manipulate the displayed portfolio data, change the subset of data being displayed, and provide any other interactive functionality that may assist a fund manager in selecting CR-Bonds to redeem. Provided with input indicating which CR-Bonds the fund manager has selected for redemption, ETF system 160 responsively generates and transmits a redemption request 456 to bond-data consolidator system 161. ETF system 160 then sends a redemption request 456 to bond-data consolidator system 161, which identifies CR-Bonds to be redeemed.

In a further aspect, ETF system 160 preferably functions to intelligently process the portfolio data in order to filter and arrange the portfolio data that is displayed. For instance, ETF system 160 may retrieve ETF investment criteria data from database 162 and apply the ETF investment criteria to select which CR-Bonds, and/or what specific portfolio data associated with each selected CR-Bond, should be displayed. The ETF system 160 may then function to arrange the selected portfolio data, such as by ranking the selected CR-Bonds to provide a suggested priority for redemption, for instance. Alternatively, ETF system 160 may select certain CR-Bonds and/or the specific portfolio data to display, without any particular arrangement, or conversely, arrange and display all portfolio data (such as by ranking and displaying all CR-Bonds in the ETF portfolio). Further, it is also within the scope of the invention that the ETF system 160 may simply display all portfolio data, without any particular arrangement.

In another alternative embodiment, ETF system 160 may further apply the ETF investment criteria to automatically select which CR-Bonds to redeem. As such, it is possible that redemption request 456 may be generated and sent without any input from the fund manager.

When bond-data consolidator system 161 receives the redemption request 456, the bond-data consolidator system 161 preferably validates the request. If the request is validated, bond-data consolidator system 161 sends a redemption request 458 to bond-issuing company workstation 181, which identifies the CR-Bonds being redeemed. On the other hand, if the bond-data consolidator system 161 determines that the redemption request is invalid (e.g., that the conditions required for an early redemption have not been satisfied or that an error of some other type has occurred), bond-data consolidator system 161 may send an error message to ETF system 160.

When the redemption request 458 is received at bond-issuing company workstation 181, the bond-issuing company 121 may elect whether to make payment in cash, as shown by transaction 410, or to make payment in stock, as shown by transaction 420. Accordingly, the bond-issuing company workstation 181 sends a cash/stock indication to bond-data consolidator system 161, which indicates the form of payment elected by bond-issuing company 121. If the payment is in stock, the bond-issuing company workstation 181 sends a bond-issuance instruction 480 to bond-data consolidator system 161, which instructs the bond-data consolidator 118 to issue shares from the shelf registration 123. Accordingly bond-data consolidator system 161 may access shelf registration database 183 to verify that the shares are available, and then proceed to issue the shares to ETF 102, as shown by transaction 412. Also as shown by transaction 412, if the bond-issuing company 121 alternatively elects payment in monetary funds, these funds are transferred to ETF 102.

In the event of payment by stock, ETF 102 preferably proceeds to sell the stock on an equity market or exchange, as shown by transaction 430. To implement transaction 420, ETF System 162 may send a sell order 468 to market or exchange system 163, which typically responds with an electronic stock sale confirmation 469. This arrangement may help to reduce risk associated with CR-Bonds, which in turn may provide lower rates for issuing companies. In particular, the ETF is structured with the objective that the inflow of funds provided by the sale of the stock in a redemption event, should generally offset the outflow of funds to investors from the sale of ETF shares, which initiated the redemption event. Alternatively, when the bond-data consolidator 118 receives or issues the stock, the bond-data consolidator 118 may sell the stock on behalf of the ETF 102, and transfer the funds resulting from the sale to ETF 102.

In a further aspect, while the features and functions of ETF 102, bond-data consolidator 118, and/or bond-issuing company 121 are described above in reference to the scenario where an IF (i.e., ETF 102) redemption event triggers the redemption event, the above-described features and functions may apply equally in scenarios where a redemption event is initiated at the maturity of a CR-Bond or where a redemption event is initiated in response to a credit event.

Accordingly, ETF system 160 is preferably configured to monitor information relating to the credit of bond-issuing companies. Further, bond-data consolidator system 161 is preferably configured to assist in this process by collecting, aggregating, and sending such credit information to ETF system 160 periodically and/or when otherwise appropriate. Bond-data consolidator system 161 may further function to analyze the credit information it collects and detect when a credit event occurs, in which case it may send a credit event alert to ETF system 160.

Under the terms of a CR-Bond, various occurrences and situations may constitute a “credit event.” For example, the lowering of a company's credit rating may be defined as a credit event. As other examples, the stock of a company falling below a predetermined threshold price, or a stock price move greater than a predetermined percentage, or an unplanned change in corporate directors or executives, or a default on other debt obligations, may be defined as a credit event. Other examples are also possible.

Exemplary embodiments of the invention have been described above. Those skilled in the art will appreciate that changes may be made to the embodiment described without departing from the true spirit and scope of the invention as defined by the claims.

1-20. (canceled)

21. An exchange-traded fund (ETF) computer system comprising:
a processor;
a bond selection module configured to prepare a user interface that enables filtering conditional-redemption bond (CR-Bond) data by applying ETF investment criteria maintained in an investment criteria database coupled to an ETF server, the module further configured to be accessible via an authentication, authorization, and accounting (AAA) server, wherein filtering CR-Bond data includes ranking a list of CR-Bonds; and
a non-transitory computer-readable storage medium storing instructions operative, when executed on the processor, to perform functions including:
receiving, at the ETF server via a secure gateway coupled to the ETF server, a request from an authorized participant (AP) workstation to generate one or more shares in an ETF;
transmitting, from the ETF server to a bond-data consolidation server via the secure gateway, an indication of interest regarding available CR-Bonds, wherein the available CR-Bonds are puttable bonds that are conditioned upon sale and redemption restrictions, wherein the sale and redemption restrictions include:
a restriction that the CR-Bonds are permitted to be purchased or redeemed only in a transaction with a corresponding bond issuer; and
a restriction that redemptions of the CR-Bonds are permitted only when an ETF redemption occurs;
receiving, at the ETF server via the secure gateway, CR-Bond offering data from the bond-data consolidator server, wherein the bond-data consolidation server is coupled to a bond-offering database, and wherein the received CR-Bond offering data identifies a plurality of available CR-Bonds offered by a plurality of bond issuers;
transmitting, from the ETF server via the secure gateway, an electronic purchase request message requesting to purchase one or more bonds selected from the identified plurality of available CR-Bonds, the message including identity and quantity data of the one or more selected bonds, the one or more selected bonds selected via the bond selection module; and
storing a plurality of shares of the ETF in a portfolio database coupled to the ETF server, wherein the ETF shares are backed by a debt portfolio including CR-Bonds issued by a plurality of companies and further including the one or more selected bonds.

22. The ETF computer system of claim 21, wherein storing a plurality of shares of the ETF in a portfolio database coupled to the ETF server comprises receiving an instruction to create shares in the ETF.

23. The ETF computer system of claim 22, wherein the instruction is received from a Depository Trust Company or an authorized participant.

24. The ETF computer system of claim 21, wherein storing a plurality of shares of the ETF in a portfolio database coupled to the ETF server comprises:
receiving a request for a creation event and responsively making a determination that a CR-Bond purchase should be initiated.

25. The ETF computer system of claim 21, wherein the ETF investment criteria include a target interest rate.

26. The ETF computer system of claim 21, wherein the bond-offering data includes the following parameters: interest rate, nominal value, offer size, and default maturity.

27. The ETF computer system of claim 21, wherein at least one of the CR-Bonds may be redeemed according to sale and redemption conditions by converting the at least one CR-Bond to stock of the bond issuer.

28. The ETF computer system of claim 27, wherein the stock used in the redemption is supported by a shelf filing.

29. The ETF computer system of claim 21, wherein the bond-offering data includes data for CR-Bonds having a range of default maturity in the range of overnight to 180 days.

30. The ETF computer system of claim 21, wherein the electronic purchase request message is transmitted to the bond-data consolidation server.

31. The method of claim 21, wherein the debt portfolio backing the ETF shares consists only of puttable CR-Bonds.

32. The method of claim 21, wherein redemptions of the CR-Bonds are further permitted when the bond issuer has a credit event.

33. An apparatus for use in an exchange-traded fund (ETF), the apparatus comprising:
a computer communications interface device and message parsing apparatus coupled to an ETF server configured to send, in response to a determination to create shares in an exchange-traded fund (ETF), an indication of interest regarding available conditional-redemption bonds (CR-Bonds) to a bond-data consolidation server via a secure gateway, and further being configured to receive, in response to the indication of interest, bond-offering data from the bond-data consolidator server via the secure gateway, wherein the bond-data consolidation server is coupled to a bond-offering database, and wherein the received bond-offering data identifies a plurality of available CR-Bonds offered by a plurality of bond issuers;
a processor configured to apply investment criteria stored in an investment criteria database coupled to the ETF server to filter the received bond-offering data to identify a subset of available CR-Bonds from the identified available CR-Bonds, wherein filtering includes ranking a list of CR-Bonds;
a display device configured to display at least the identified subset of available CR-Bonds;
an input device coupled to the computer communications interface device configured to accept input indicating selected CR-Bonds from the identified subset of the available CR-Bonds to be purchased on behalf of the ETF;
the computer communications interface device further configured to purchase the selected CR-Bonds by transmitting, to the bond-data consolidator server via the secure gateway, an electronic purchase request message comprising CR-Bond purchase data including identity data and quantity data for the selected CR-Bonds to be purchased on behalf of the ETF; and,
the computer communications interface device further configured to create shares of the ETF backed by a debt portfolio including CR-Bonds issued by a plurality of companies and further including the purchased selected CR-Bonds.

34. The apparatus of claim 33, further comprising tangible computer readable storage media containing instructions, that when executed, cause the apparatus to generate and process Depository Trust Company (DTC) messages relating to the transfer of stock associated with a redemption of the CR-Bonds.

35. The apparatus of claim 34 further comprising instructions, that when executed, cause the apparatus to process DTC messages indicating that an authorized participant (AP) has transferred monetary funds associated with an ETF creation event.

36. The apparatus of claim 33, wherein the debt portfolio backing the ETF shares consists only of puttable CR-Bonds.

37. A computer method for use in an exchange-traded fund (ETF), the method comprising:
making a determination to create shares in an exchange-traded fund (ETF) by purchasing conditional-redemption bonds (CR-Bonds);
in response to the determination to create shares, sending from an ETF server an indication of interest regarding available CR-Bonds to a bond-data consolidation server via a secure gateway coupled to the ETF server;
in response to the indication of interest, receiving at the ETF server bond-offering data from the bond-data consolidator server via the secure gateway, wherein the bond-data consolidation server is coupled to a bond-offering database, and wherein the received bond-offering data identifies available CR-Bonds offered by a plurality of bond issuers;
using a processor to process the received bond-offering data to apply electronic ETF investment criteria stored in an investment criteria database coupled to the ETF server to filter the received bond-offering data, wherein filtering the bond-offering data includes (i) ranking a list of CR-Bonds and (ii) displaying at least a subset of the available CR-Bonds identified in the received bond-offering data;
receiving input indicating selected CR-Bonds from the displayed subset of the available CR-Bonds to be purchased on behalf of the ETF;
purchasing the selected CR-Bonds, the purchasing including transmitting an electronic purchase request message to the bond-data consolidator server from the ETF server via the secure gateway, the electronic purchase request message comprising CR-Bond purchase data including identity and quantity data of the selected CR-Bonds to be purchased on behalf of the ETF;
creating shares of the ETF the ETF server, wherein creating shares of the ETF includes storing shares of the ETF in a portfolio database coupled to the ETF server, and wherein the ETF shares are backed by a debt portfolio including CR-Bonds issued by a plurality of companies and further including the purchased selected CR-Bonds;
in response to an ETF redemption, making a determination that a CR-Bond redemption should be initiated; and
in response to the determination that a CR-Bond redemption should be initiated, transmitting from the ETF server an electronic redemption request comprising identity and quantity data for at least the purchased selected CR-Bonds.
